(19) United States
(12) Patent Application Publication
(10) Pub. No.: US 2013/0083863 A1
(43) Pub. Date: Apr. 4, 2013

(54) APPARATUS AND METHOD FOR LOW COMPLEXITY FEEDBACK IN A MIMO WIRELESS NETWORK

(71) Applicant: SAMSUNG ELECTRONICS CO., LTD., Suwon-si (KR)

(72) Inventor: Ankit Gupta, Redmond, WA (US)

(73) Assignee: SAMSUNG ELECTRONICS CO., LTD., Suwon-si (KR)

(21) Appl. No.: 13/633,585

(22) Filed: Oct. 2, 2012

Related U.S. Application Data
(60) Provisional application No. 61/543,200, filed on Oct. 4, 2011.

(51) Int. Cl. H04B 15/00

(52) U.S. Cl. CPC H04B 15/00
USPC 375/267

(57) ABSTRACT

A receiver in a multiple input, multiple output (MIMO) system is configured to perform a method for generating channel quality feedback information. The method includes receiving, from a MIMO transmitter, pilot signals in each MIMO layer. The method also includes selecting an optimal precoder matrix for each MIMO layer using a first detection metric. The method further includes determining a signal-to-noise ratio (SNR) for each MIMO layer using a second detection metric and the optimal precoder.

### CROSS-REFERENCE TO RELATED APPLICATION(S) AND CLAIM OF PRIORITY

The present application claims priority to U.S. Provisional Patent Application Ser. No. 61/543,200 filed Oct. 4, 2011, entitled “METHOD AND APPARATUS FOR LOW COMPLEXITY FEEDBACK”. The content of the above-identified patent documents is incorporated herein by reference.

### TECHNICAL FIELD

The present application relates generally to determination of channel quality feedback in wireless mobile communication systems and, more specifically, to an improved low-complexity feedback algorithm that is suitable for use in a multiple input, multiple output (MIMO) system.

### BACKGROUND

Detection of signals and providing periodic channel quality feedback in multiple input, multiple output (MIMO) wireless transmission systems presents a challenging problem involving complex and extensive computations. For mobile handsets, the number of computations that must be performed to provide feedback for each transmitted symbol can require substantial power consumption, decreasing battery life.

### SUMMARY

For use in a receiver in a multiple input, multiple output (MIMO) system, a method for generating channel quality feedback information is provided. The method includes receiving, from a MIMO transmitter, pilot signals in each MIMO layer. The method also includes selecting an optimal precoder matrix for each MIMO layer using a first detection metric. The method further includes determining a signal-to-noise ratio (SNR) for each MIMO layer using a second detection metric and the optimal precoder.

For use in a receiver in a MIMO system, an apparatus configured to generate channel quality feedback information is provided. The apparatus includes a processor. The processor is configured to receive, from a MIMO transmitter, pilot signals in each MIMO layer. The processor is also configured to select an optimal precoder matrix for each MIMO layer using a first detection metric. The processor is further configured to determine a SNR for each MIMO layer using a second detection metric and the optimal precoder.

A receiver configured for use in a MIMO system and capable of generating channel quality feedback information is provided. The receiver includes a plurality of antenna elements and a processor coupled to the plurality of antenna elements. The processor is configured to receive, from a MIMO transmitter, pilot signals in each MIMO layer. The processor is also configured to select an optimal precoder matrix for each MIMO layer using a first detection metric. The processor is further configured to determine a SNR for each MIMO layer using a second detection metric and the optimal precoder.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network capable of implementing MIMO techniques, according to one or more embodiments of this disclosure;

FIGS. 2A and 2B illustrate components and signals within a transmitter and a receiver for a MIMO signal transmission system in a wireless network, according to one or more embodiments of this disclosure;

FIG. 3 depicts a representative MIMO system having nTx transmitter antennas and nRx receiver antennas;

FIG. 4 depicts a plot illustrating a number of different functions that have the same optimization over a sparse set; and

FIGS. 5A through 5F illustrate comparative performance plots in a number of simulations for a minimum mean square error (MMSE) based feedback metric and a detector using the maximum ratio combining (MRC) metric described herein, according to an embodiment of this disclosure.

### DETAILED DESCRIPTION

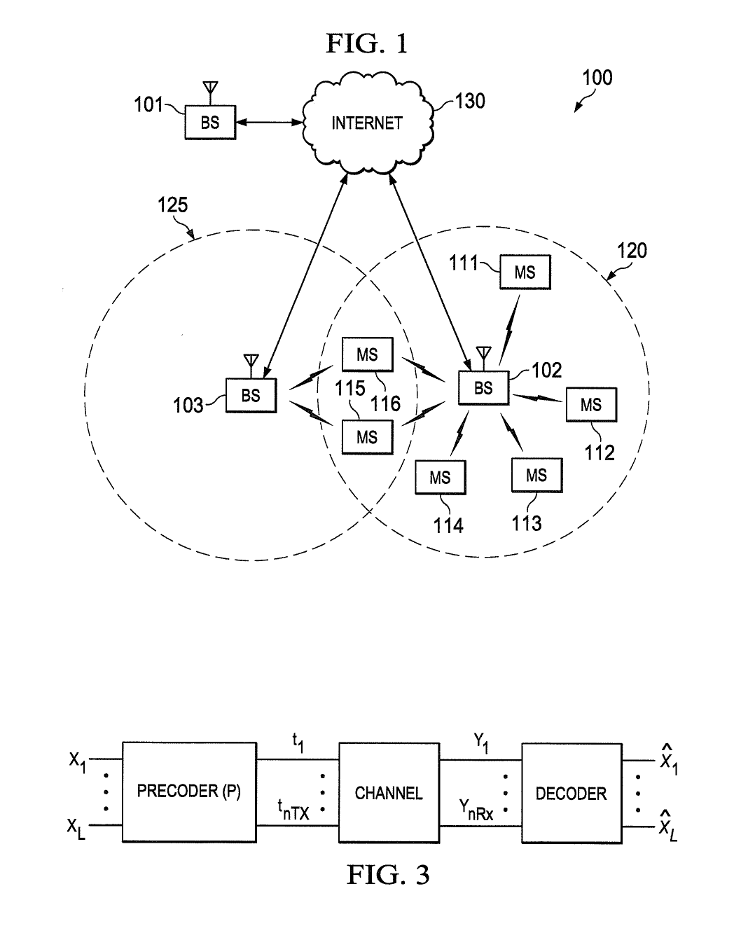

FIGS. 1 through 5F, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following documents and standards descriptions are hereby incorporated into the present disclosure as if fully set forth herein:

“Evolved Universal Terrestrial Radio Access (E-UTRA); User Equipment (UE) Radio Access Capabilities (Release 10)”, 3GPP Technical Specification No. 36.211, version 10.2.0, June 2011 (hereinafter “REF1”); and “Evolved Universal Terrestrial Radio Access (E-UTRA); User Equipment (UE) radio transmission and reception (Release 10)”, 3GPP Technical Specification No. 36.101, version 10.3.0, June 2011 (hereinafter “REF2”).

MIMO antenna systems are an integral part of fourth generation communications systems such as Long Term Evolution (LTE), LTE Advanced (LTE-A) and Worldwide Interoperability for Microwave Access (WiMAX). To achieve high spectral efficiency, as many as eight antennas are supported at both the receiver and transmitter in LTE Release 10. In addition, higher order modulations such as Quadrature Amplitude Modulation with 64 constellation points (64-QAM) are used in a high signal-to-noise ratio (SNR) scenario.

FIG. 1 is a high level diagram illustrating an exemplary wireless network implementing MIMO techniques, according to one or more embodiments of this disclosure. The wireless network 100 illustrated in FIG. 1 is provided solely for purposes of explaining the subject matter of the present disclosure, and is not intended to suggest any limitation regarding the applicability of that subject matter. Other wireless networks may employ the subject matter depicted in the drawings and described herein without departing from the scope of the present disclosure. In addition, those skilled in the art will recognize that the complete structure and operation of a wireless network and the components thereof are depicted in the drawings and described therein. Instead, for simplicity and clarity, only so much of the structure and operation of the wireless network and the components thereof as are unique to the present disclosure or necessary for an understanding of the present disclosure are depicted and described.

In the illustrated embodiment, wireless network 100 includes a base station (BS) 101, BS 102, and BS 103. Depending on the network type, other well-known terms may be used instead of “base station,” such as “Evolved Node B” (eNB) or “access point” (AP). For simplicity and clarity, the term “base station” will be used herein to refer to the network infrastructure components that provide or facilitate wireless communications network access to remote (mobile or fixed) terminals.

The BS 101 communicates with BS 102 and BS 103 via network 130 operating according to a standardized protocol (e.g., X2 protocol), via a proprietary protocol, or preferably via Internet protocol (IP). IP network 130 may include any IP-based network or a combination thereof, such as the Internet, a proprietary IP network, or another data network.

The BS 102 provides wireless broadband access to a first plurality of mobile stations (MSs) within coverage area 120 of BS 102. In the example illustrated, the first plurality of MSs includes MS 111, which may be located in a small business; MS 112, which may be located in an enterprise; MS 113, which may be located in a wireless fidelity (WiFi) hotspot; MS 114, which may be located in a first residence; MS 115, which may be located in a second residence; and MS 116, which may be a mobile device, such as a cell phone, a wireless laptop, a wireless-enabled tablet, or the like. For simplicity and clarity, the term “mobile station” or “MS” is used herein to designate any remote wireless equipment that wirelessly accesses or communicates with a BS, whether the MS is a mobile device (e.g., cell phone, wireless-enabled tablet or laptop, etc.) or is normally considered a stationary device (e.g., desktop personal computer, wireless television receiver, etc.). In other systems, other well-known terms may be used instead of “mobile station,” such as “user equipment” (UE), “subscriber station” (SS), “remote terminal” (RT), “wireless terminal” (WT), and the like.

The BS 103 provides wireless broadband access to a second plurality of MSs within coverage area 125 of BS 103. The second plurality of MSs includes MS 115 and MS 116. In an exemplary embodiment, BSs 101-103 communicate with each other and with MSs 111-116 using MIMO techniques. While only six MSs are depicted in FIG. 1, it will be understood that wireless network 100 may provide wireless broadband access to additional MSs.

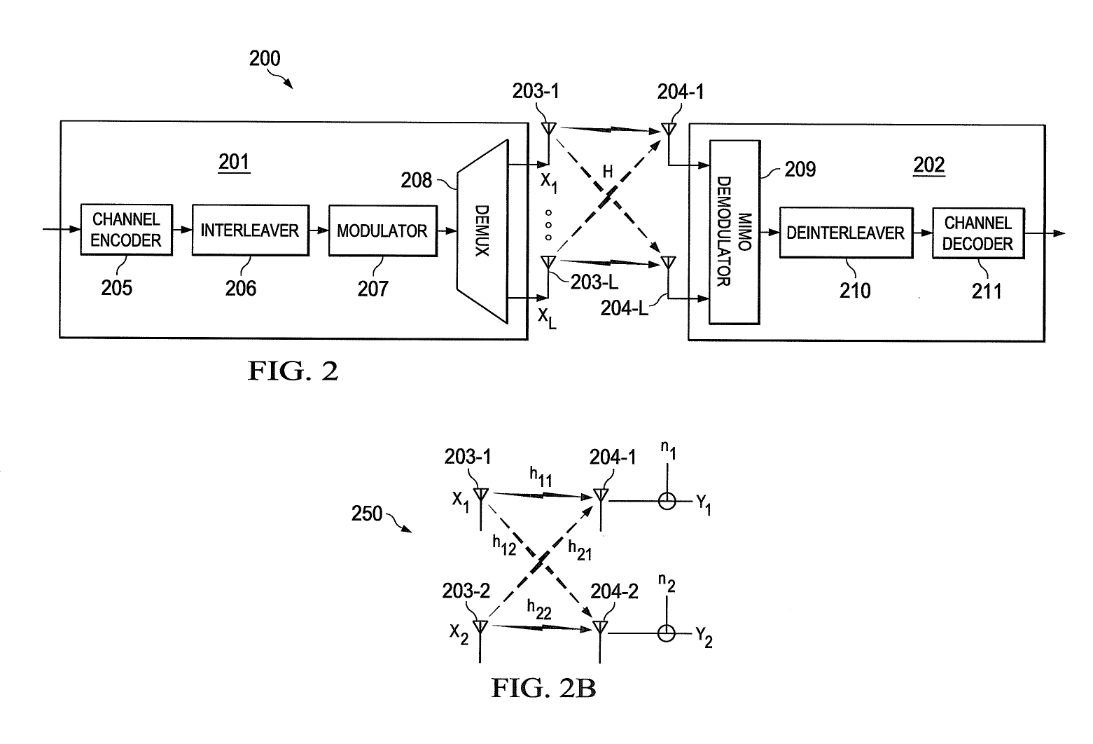

FIGS. 2A and 2B are diagrams of components and signals within a transmitter and a receiver for a MIMO signal transmission system in a wireless network, according to one or more embodiments of this disclosure.

As shown in FIG. 2A, the MIMO signal transmission system 200 includes a transmitter 201 coupled to an array of L antenna or antenna elements 203-1 to 203-L and a receiver 202 coupled to an array of L antenna or antenna elements 204-1 to 204-L, with the transmitter 201 forming part of one of BSs 101-103 and the receiver 202 forming part of one of the MSs 111-116 in the embodiment. As understood by those skilled in the art, each BS 101-103 and each MS 111-116 includes both a transmitter and a receiver each separately coupled to the respective antenna array to transmit or receive radio frequency signals over channel H, such that the transmitter 201 may alternatively be disposed within one of the MSs 111-116 and the receiver 202 may alternatively be disposed within one of the BSs 101-103.

In the example depicted, the transmitter 201 includes encoding and modulation circuitry comprising a channel encoder 205 receiving and encoding data for transmission, an interleaver 206 coupled to the channel encoder 205, a modulator 207 coupled to the interleaver 206, and a de-multiplexer 208 coupled to the modulator 207 and antenna elements 203-1 to 203-L. In the example depicted, the receiver 202 includes a MIMO demodulator 209 coupled to the antenna elements 204-1 to 204-L, a de-interleaver 210 coupled to the MIMO demodulator 209 and a channel decoder 211 coupled to the de-interleaver 210. In addition, transmitter 201 and receiver 202 may each include a programmable processor or controller including and/or connected to memory and coupled to the respective transmitter and receiver chains for controlling operation of the respective BS or MS. Using such components, synchronization signals are transmitted by a BS and received by an MS in the manner described in further detail below.

FIG. 2B illustrates an example of MIMO signal transmission. As discussed above, MIMO signal transmission utilizes multiple antenna elements at both the transmitter and receiver. The MIMO transmission arrangement 250 illustrated by FIG. 2B includes transmitter antenna elements 203-1 and 203-2 located within one of BSs 101, 102 and 103, and receiver antenna elements 204-1 and 204-2 located within one of MSs 111, 112, 113, 114, 115 and 116. For simplicity, a 2×2 MIMO system (i.e., two transmit antennas and two receive antennas) MIMO system is illustrated, although those skilled in the art will understand how the mathematics discussed below extends to larger systems. The mathematical equation governing signals transmitted over channel H between antenna elements 203-1 and 203-2 and antenna elements 204-1 and 204-2 is given as:

$$[ \begin{matrix}{Y}_{1} \\ {Y}_{2}\end{matrix} ] = [ \begin{matrix}{h}_{11} & {h}_{12} \\ {h}_{21} & {h}_{22}\end{matrix} ] [ \begin{matrix}{X}_{1} \\ {X}_{2}\end{matrix} ] + [ \begin{matrix}{n}_{1} \\ {n}_{2}\end{matrix} ]$$

where Y₁ and Y₂ are the received signal at antenna elements 204-1 and 204-2, respectively, X₁ and X₂ are the symbols transmitted by antenna elements 203-1 and 203-2, respectively, h₁₁ and h₁₂ represent characteristics of channel H between antenna element 203-1 and antenna elements 204-1 and 204-2, respectively, h₂₁ and h₂₂ represent channel characteristics between antenna element 203-2 and antenna elements 204-1 and 204-2, respectively, and n₁ and n₂ are independent identically distributed Gaussian noise signals with variance σ².

MIMO detection is used to recover estimates of the bits in X₁ and X₂. Since the system is coded, interest is focused on the soft estimates (i.e., log-likelihood ratios or “LLRs”) instead of the actual bits themselves, where the soft estimates are then fed to the turbo decoder. The performance of any detector is finally evaluated according to the resulting block error rate (BLER) (sometimes also referred to as frame error rate or “FER”) performance as a function of the SNR.

In LTE Release 8, periodic feedback of the channel state is sent from the UE to the ENodeB. This feedback includes three components:
Channel Quality Indicator (CQI): Indicates the spectral efficiency of each layer in the channel;
Precoding Matrix Indicator (PMI): Precoder matrix to be used with the channel;
Rank Indicator (RI): The number of layers that are feasible for the channel.

To illustrate these concepts, FIG. 3 depicts a representative MIMO system having nTx transmitter antennas and nRx receiver antennas. The MIMO system 300 may represent one or more of the MIMO systems depicted in FIGS. 1, 2A, and 2B. The number of layers that are transmitted on the MIMO system 300 is L. The channel matrix, H, has dimensions (nRx×nTx), while the precoder matrix P has dimensions (nTx×L). The equation governing this system is given as:

Y=HPX+n [Eqn. 1]

where Y is a vector of length nRx, P is the precoder matrix, and X is a vector of length L, and n is a noise vector.

The rank of this system is equal to L. The precoder is restricted to a finite set of choices. For example, for an example 4×4 MIMO system, the precoder can only be selected from Table 1 below, where

$${W}_{n} = I - \frac{2 {u}_{n} {u}_{n}^{H}}{{u}_{n}^{H} {u}_{n}} .$$

One approach to selecting the rank and precoder for feedback is to work backwards from the detection algorithm used in the receiver. For example, a MIMO system is considered that includes a receiver that uses a MMSE detector. A MMSE filter for the system in Equation 1 is given as:

F_{MMSE}=(HP)^{H}(HPP^{H}H^{H}+σ²I)⁻¹ [Eqn. 2]

where σ² is a variance of the noise. The MMSE filter is dependent on the MIMO channel H, which can be estimated at the receiver using pilot symbols transmitted from the base station.

The MMSE filter can be applied to Equation 1 to get:

F_{MMSE}Y=F_{MMSE}HPX+F_{MMSE}n [Eqn. 3]

Equation 3 can be decomposed as L separate equations, each of the L equations having the form:

\hat{X}_{L}=\tilde{H}ₗₗXₗ+Σ_{{i=1,i≠1}}^{L}\tilde{H}ₗᵢXᵢ+ñₗ [Eqn. 4]

where \tilde{Y}ₗ and ñₗ are the components of the vectors F_{MMSE}Y and F_{MMSE}n respectively, and Hᵢⱼ are the components of the L×L matrix F_{MMSE}HP.

Using Equation 4, the signal-to-noise ratio (SNR) for layer l can be determined as:

$${SNR}_{l} = \frac{{\vert {\tilde{H}}_{ll} \vert}^{2}}{{\sum }_{i = 1 , i \neq l}^{L} {\vert {H}_{li} \vert}^{2} + {\tilde{σ}}_{l}^{2}} \qquad [ Eqn . 5 ]$$

where \tilde{σ}ₗ² represents the noise variance experienced on layer l, as per Equation 4.

The SNR per layer may be mapped to determine effective spectral efficiency per layer. Using the spectral efficiency per layer, it is possible to determine how much throughput can be achieved with various combinations of precoder matrices and rank. The combination that provides the best throughput can be indicated. The CQI may then be reported based on that rank and precoder.

The MMSE matrix in Equation 2 may need to be reevaluated for each precoder matrix. This results in a large number of mathematical operations at the receiver. For example, in a 4×4 MIMO system, there are 16 precoder choices for each selection of rank ε{1, 2, 3, 4}, as shown in Table 1. The number of multiplications required to compute the feedback using this technique for each resource block is 9584.

In accordance with an embodiment of this disclosure, a new feedback algorithm uses a new, low-complexity metric to determine the optimal precoder. Using the new metric, the optimal precoder is quickly determined without the need to evaluate the MMSE matrix for each precoder candidate. The new metric is based on the following observation. Suppose there is a function f(x) that is to be maximized over a finite and sparse set. Then there is an infinite number of functions fᵢ(X) indexed by i, such that argmax_{xεS}(f(x))=argmax_{xεS}(fᵢ(x)). An example is shown in FIG. 4, where three very different functions have the same maximizing value x₂ over the sparse set {x₁, x₂, x₃, x₄}. Therefore, to find the optimizer of a given function, it may be advantageous to compute the optimizer of another function that is computationally easier.

In one embodiment of this disclosure, the new metric is based upon the maximum ratio combining (MRC) detection metric, which has substantially lower complexity than the original MMSE metric. Use of the MRC detection metric instead of the MMSE metric is based on the fact that, over a sparse set, many different functions have the same optimizing argument. Simulation results are provided below that establish that the low complexity MRC metric is a good substitute for the MMSE metric.

To explain the MRC metric, it is helpful to describe the MRC detector as follows. Considering Equation 1 (shown above). To detect the i^{th} layer, Equation 1 is multiplied by (HPᵢ)^{H}. The result of the multiplication is the following:

(HPᵢ)^{H}Y=|HPᵢ|²Xᵢ+Σ_{j=1,j≠i}^{L}Pᵢ^{H}H^{H}HPⱼXⱼ+(HPᵢ)^{H}n [Eqn. 6]

Thus, the SNR using the MRC detector is given as:

$${SNR}_{i} = \frac{{\vert {HP}_{i} \vert}^{4}}{{\sum }_{j = 1 , j \neq i}^{L} {\vert {P}_{i}^{H} {H}^{H} {HP}_{j} \vert}^{2} + {\vert {HP}_{i} \vert}^{2}} . \qquad [ Eqn . 7 ]$$

Since the objective of the new metric is reduced computational complexity, the denominator of the right side of Equation 7 can be ignored. This eliminates the need to calculate the cross terms Pᵢ^{H}H^{H}HPⱼ. Equation 7 is thus reduced to the following:

SNRᵢ∝|HPᵢ|⁴ [Eqn. 8]

Finally we choose a precoder that maximizes the quantity in Equation 8, using the following equation:

f(SNRᵢ₌₁^{L})=Σᵢ₌₁^{L}SNRᵢ [Eqn. 9]

It will be understood by those skilled in the art that the use of Equations 8 and 9 is just one of many possible choices for the SNR, and f(SNRᵢ₌₁^{L}) that could be made while choosing a feedback algorithm metric.

In summary, the feedback algorithm proceeds as follows:

Stage 1) Select the optimal precoder based upon the MRC metric, using Equation 9.

Stage 2) Use the optimal precoder for each rank to report the best rank and PMI based upon the aforementioned MMSE metric.

Use of the MRC metric in the feedback algorithm described herein provides a significant savings in complex computations. For example, in a 4×4 MIMO system, the original MMSE based algorithm requires 9584 multiplications. In contrast, use of the MRC metric described herein results in a feedback algorithm that requires only 625 multiplications. Thus, the number of multiplications is reduced by a factor of 15.33.

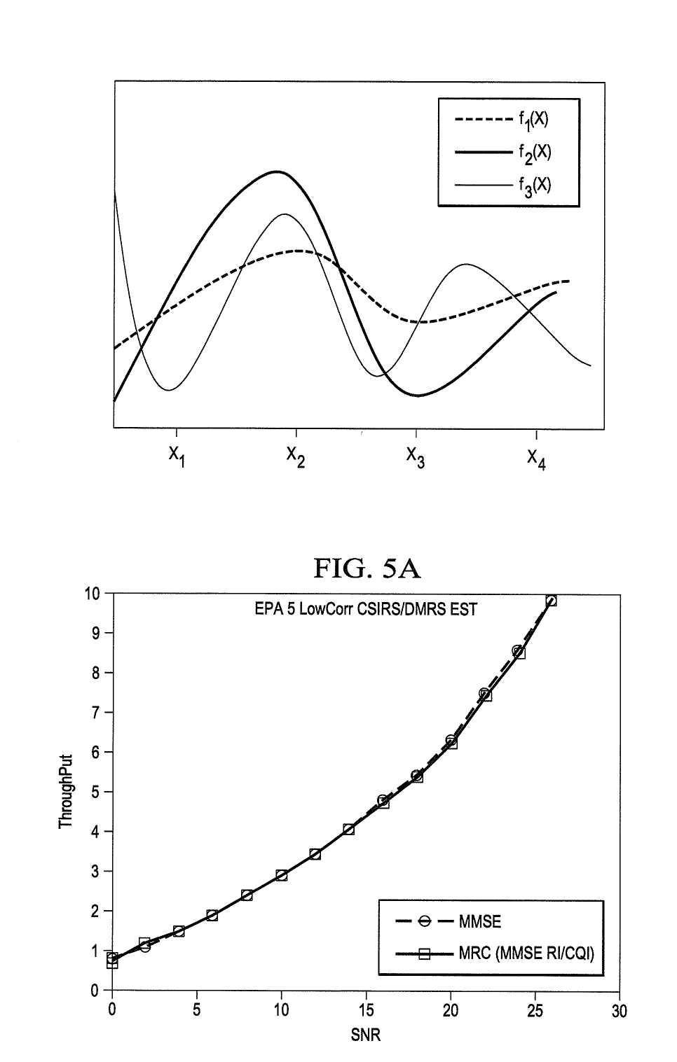

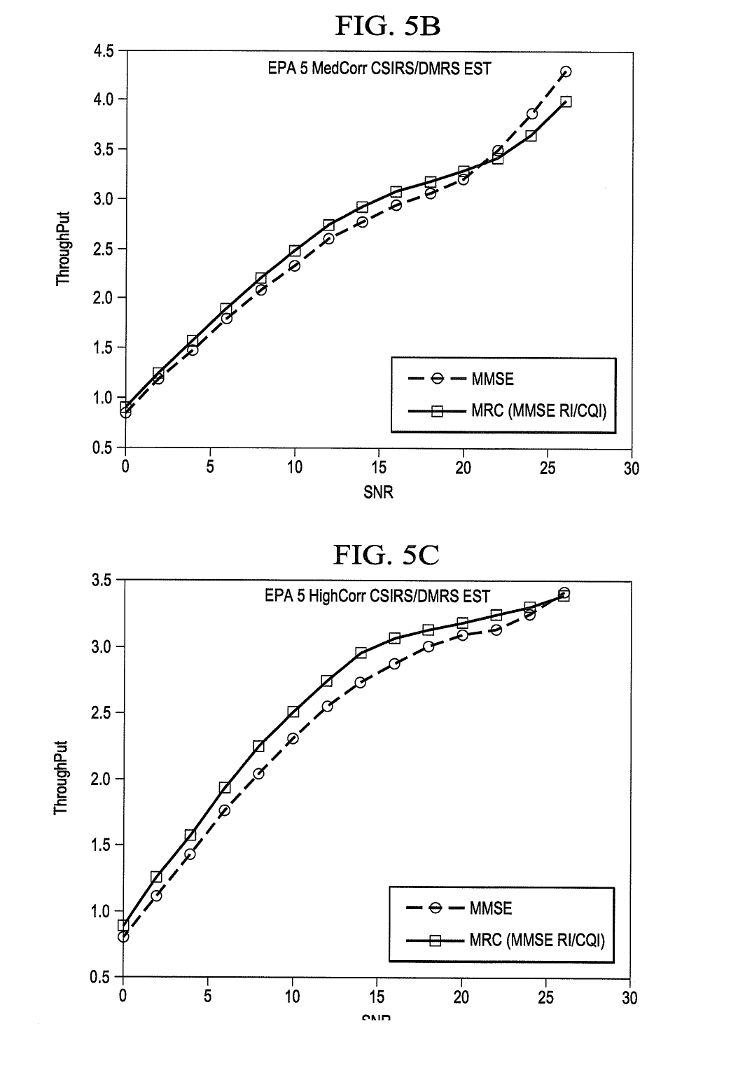

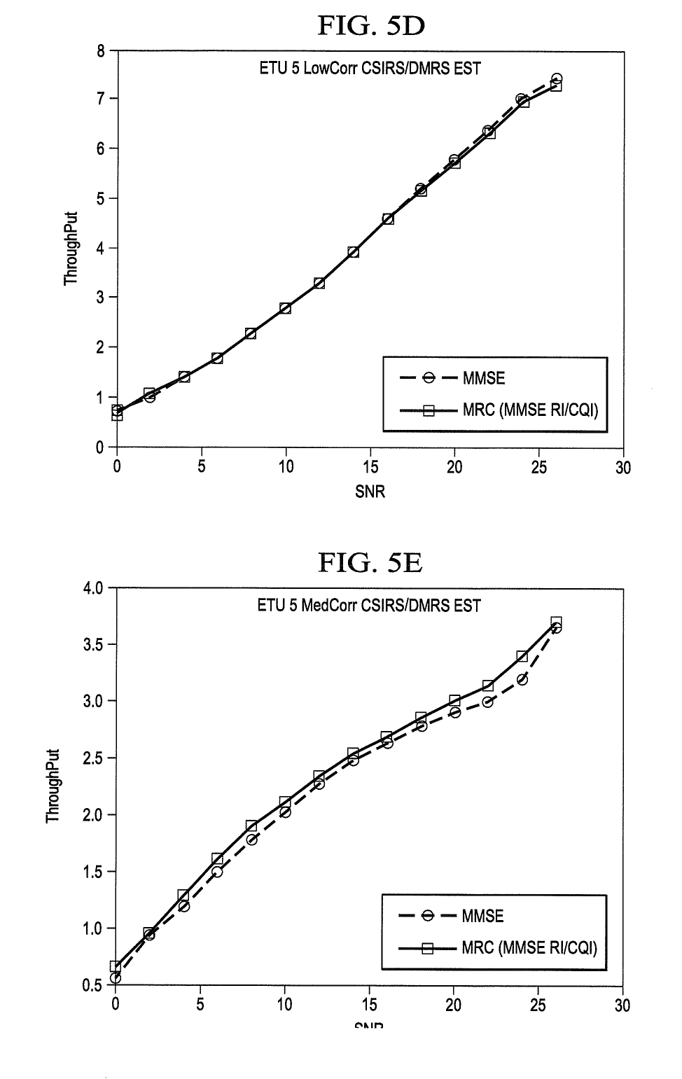

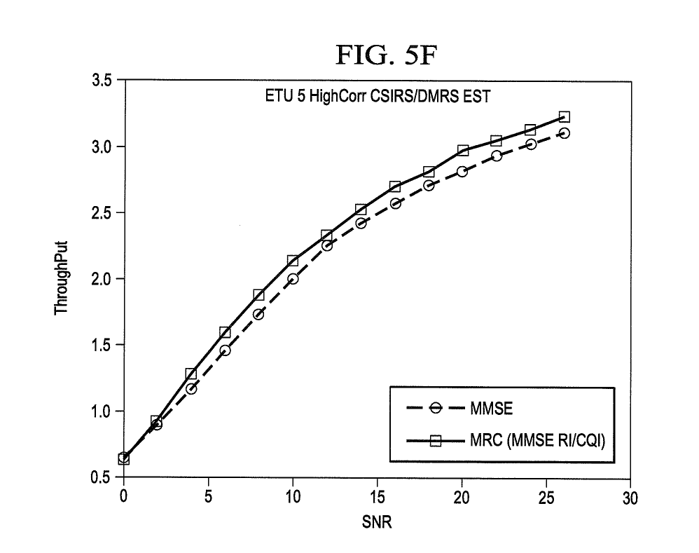

FIGS. 5A through 5F illustrate comparative performance plots in a number of simulations from REF2 for the original MMSE metric and a detector using the MRC metric described herein, according to an embodiment of this disclosure. The performance is evaluated for low, medium, and high correlation to gauge the effect of neglecting the interference term in Equation 8. FIG. 5A depicts results from a scenario from REF2 with a low correlation Doppler 5 Hz EPA channel. FIG. 5B depicts results from a scenario with a medium correlation Doppler 5 Hz EPA channel. FIG. 5C depicts results from a scenario with a high correlation Doppler 5 Hz EPA channel. FIG. 5D depicts results from a scenario from REF2 with a low correlation Doppler 5 Hz ETU channel. FIG. 5E depicts results from a scenario with a medium correlation Doppler ETU EPA channel. FIG. 5F depicts results from a scenario with a high correlation Doppler 5 Hz ETU channel.

As shown in FIGS. 5A through 5F, the MRC metric provides results that are nearly as good as the original MMSE metric in certain scenarios, and even better than the MMSE metric in other scenarios, while computational complexity is 15 times less than the original MMSE metric. It is observed that neglecting interference from other layers does not harm the MRC-based reduced complexity approach for high and medium correlations. In fact, the MRC metric outperforms the original MMSE metric in these scenarios.

The embodiments described above provide a very low complexity MIMO detection algorithm that is suitable for many applications, including use in LTE-Advanced modem chips. The disclosed embodiments of the detection algorithm provide increased throughput, improved cellular reception, and improved battery power conservation.

Although the present disclosure has been described with an exemplary embodiment, various changes and modifications may be suggested to one skilled in the art. It is intended that the present disclosure encompass such changes and modifications as fall within the scope of the appended claims.

TABLE 1
4 × 4 MIMO Precoders

| Codebook | | Number of layers ν | | | |
|---|---|---|---|---|---|
| index | uₙ | 1 | 2 | 3 | 4 |
| 0 | u₀ = [1 −1 −1 −1]^{T} | W₀^{{1}} | W₀^{{14}}/\sqrt{2} | W₀^{{124}}/\sqrt{3} | W₀^{{1234}}/2 |
| 1 | u₁ = [1 −j 1 j]^{T} | W₁^{{1}} | W₁^{{12}}/\sqrt{2} | W₁^{{123}}/\sqrt{3} | W₁^{{1234}}/2 |
| 2 | u₂ = [1 1 −1 1]^{T} | W₂^{{1}} | W₂^{{12}}/\sqrt{2} | W₂^{{3214}}/2 | W₂^{{3214}}/2 |
| 3 | u₃ = [1 j 1 −j]^{T} | W₃^{{1}} | W₃^{{12}}/\sqrt{2} | W₃^{{123}}/\sqrt{3} | W₃^{{3214}}/2 |
| 4 | u₄ = [1 (−1 − j)/\sqrt{2} −j (1 − j)/\sqrt{2}]^{T} | W₄^{{1}} | W₄^{{14}}/\sqrt{2} | W₄^{{124}}/\sqrt{3} | W₄^{{1234}}/2 |
| 5 | u₅ = [1 (1 − j)/\sqrt{2} j (−1 − j)/\sqrt{2}]^{T} | W₅^{{1}} | W₅^{{14}}/\sqrt{2} | W₅^{{1234}}/2 | W₅^{{1234}}/2 |
| 6 | u₆ = [1 (1 + j)/\sqrt{2} −j (−1 + j)/\sqrt{2}]^{T} | W₆^{{1}} | W₆^{{13}}/\sqrt{2} | W₆^{{134}}/\sqrt{3} | W₆^{{1324}}/2 |
| 7 | u₇ = [1 (−1 + j)/\sqrt{2} j (1 + j)/\sqrt{2}]^{T} | W₇^{{1}} | W₇^{{13}}/\sqrt{2} | W₇^{{1324}}/2 | W₇^{{1324}}/2 |
| 8 | u₈ = [1 −1 1 1]^{T} | W₈^{{1}} | W₈^{{12}}/\sqrt{2} | W₈^{{124}}/\sqrt{3} | W₈^{{1234}}/2 |
| 9 | u₉ = [1 −j −1 −j]^{T} | W₉^{{1}} | W₉^{{14}}/\sqrt{2} | W₉^{{134}}/\sqrt{3} | W₉^{{1234}}/2 |
| 10 | u₁₀ = [1 1 1 −1]^{T} | W₁₀^{{1}} | W₁₀^{{13}}/\sqrt{2} | W₁₀^{{1324}}/2 | W₁₀^{{1324}}/2 |
| 11 | u₁₁ = [1 j −1 j]^{T} | W₁₁^{{1}} | W₁₁^{{13}}/\sqrt{2} | W₁₁^{{134}}/\sqrt{3} | W₁₁^{{1324}}/2 |
| 12 | u₁₂ = [1 −1 −1 1]^{T} | W₁₂^{{1}} | W₁₂^{{12}}/\sqrt{2} | W₁₂^{{1234}}/2 | W₁₂^{{1234}}/2 |
| 13 | u₁₃ = [1 −1 1 −1]^{T} | W₁₃^{{1}} | W₁₃^{{1324}}/2 | W₁₃^{{1324}}/2 | W₁₃^{{1324}}/2 |
| 14 | u₁₄ = [1 1 −1 −1]^{T} | W₁₄^{{1}} | W₁₄^{{13}}/\sqrt{2} | W₁₄^{{123}}/\sqrt{3} | W₁₄^{{3214}}/2 |
| 15 | u₁₅ = [1 1 1 1]^{T} | W₁₅^{{1}} | W₁₅^{{12}}/\sqrt{2} | W₁₅^{{1234}}/2 | W₁₅^{{1234}}/2 |

What is claimed is:

1. For use in a receiver in a multiple input, multiple output (MIMO) system, a method for generating channel quality feedback information, the method comprising:
receiving, from a MIMO transmitter, pilot signals in each MIMO layer;
selecting an optimal precoder matrix for each MIMO layer using a first detection metric; and
determining a signal-to-noise ratio (SNR) for each MIMO layer using a second detection metric and the optimal precoder.

2. The method of claim 1, further comprising:
transmitting, to the MIMO transmitter, the optimal precoder for each MIMO layer as channel quality feedback information.

3. The method of claim 1, wherein the first detection metric requires substantially fewer calculations than the second detection metric.

4. The method of claim 3, wherein the first detection metric comprises a maximum ratio combining (MRC) metric and the second detection metric comprises a minimum mean square error (MMSE) metric.

5. The method of claim 4, wherein the optimal precoder is selected according to the equation:
$$f ( {SNR}_{i = 1}^{L} ) = {\sum }_{i = 1}^{L} {SNR}_{i}$$
$$where$$
$${SNR}_{i} ∝ {\vert {HP}_{i} \vert}^{4}$$
where H is a MIMO channel matrix, Pᵢ is an ith vector in a precoder matrix, and L is a number of layers in the MIMO system.

6. The method of claim 1, further comprising determining a spectral efficiency for each MIMO layer using the second detection metric and the optimal precoder.

7. The method of claim 1, wherein the receiver is a mobile station and the transmitter is a base station in the MIMO system.

8. For use in a receiver in a multiple input, multiple output (MIMO) system, an apparatus configured to generate channel quality feedback information, the apparatus comprising:
a processor configured to:
receive, from a MIMO transmitter, pilot signals in each MIMO layer;
select an optimal precoder matrix for each MIMO layer using a first detection metric; and
determine a signal-to-noise ratio (SNR) for each MIMO layer using a second detection metric and the optimal precoder.

9. The apparatus of claim 8, the processor further configured to:
transmit, to the MIMO transmitter, the optimal precoder for each MIMO layer as channel quality feedback information.

10. The apparatus of claim 8, wherein the first detection metric requires substantially fewer calculations than the second detection metric.

11. The apparatus of claim 10, wherein the first detection metric comprises a maximum ratio combining (MRC) metric and the second detection metric comprises a minimum mean square error (MMSE) metric.

12. The apparatus of claim 11, wherein the optimal precoder is selected according to the equation:
$$f ( {SNR}_{i = 1}^{L} ) = {\sum }_{i = 1}^{L} {SNR}_{i}$$
$$where$$
$${SNR}_{i} ∝ {\vert {HP}_{i} \vert}^{4}$$
where H is a MIMO channel matrix, Pᵢ is an ith vector in a precoder matrix, and L is a number of layers in the MIMO system.

13. The apparatus of claim 8, the processor further configured to determine a spectral efficiency for each MIMO layer using the second detection metric and the optimal precoder.

14. The apparatus of claim 8, wherein the receiver is a mobile station and the transmitter is a base station in the MIMO system.

15. A receiver configured for use in a multiple input, multiple output (MIMO) system and capable of generating channel quality feedback information, the receiver comprising:
a plurality of antenna elements; and
a processor coupled to the plurality of antenna elements, the processor configured to:
receive, from a MIMO transmitter, pilot signals in each MIMO layer;
select an optimal precoder matrix for each MIMO layer using a first detection metric; and
determine a signal-to-noise ratio (SNR) for each MIMO layer using a second detection metric and the optimal precoder.

16. The receiver of claim 15, the processor further configured to:
transmit, to the MIMO transmitter, the optimal precoder for each MIMO layer as channel quality feedback information.

17. The receiver of claim 15, wherein the first detection metric requires substantially fewer calculations than the second detection metric.

18. The receiver of claim 17, wherein the first detection metric comprises a maximum ratio combining (MRC) metric and the second detection metric comprises a minimum mean square error (MMSE) metric.

19. The receiver of claim 18, wherein the optimal precoder is selected according to the equation:
$$f ( {SNR}_{i = 1}^{L} ) = {\sum }_{i = 1}^{L} {SNR}_{i}$$
$$where$$
$${SNR}_{i} ∝ {\vert {HP}_{i} \vert}^{4}$$
where H is a MIMO channel matrix, Pᵢ is an ith vector in a precoder matrix, and L is a number of layers in the MIMO system.

20. The receiver of claim 15, the processor further configured to determine a spectral efficiency for each MIMO layer using the second detection metric and the optimal precoder.
